(19) United States
(12) Patent Application Publication
(10) Pub. No.: US 2005/0279023 A1
(43) Pub. Date: Dec. 22, 2005

(54) Hydrogen generation system with methanation unit

(76) Inventors: Albert E. Stewart, Sylmar, CA (US); M. Andrew Crews, Bullard, TX (US); Kenneth M. Sprouse, Northridge, CA (US); Jeffrey A. Mays, Woodland Hills, CA (US)

Correspondence Address: HARNESS, DICKEY & PIERCE, P.L.C., P.O. BOX 828, BLOOMFIELD HILLS, MI, 48303, US

(21) Appl. No.: 10/869,641

(22) Filed: Jun. 16, 2004

(51) Int. Cl. C01B 3/24

(52) U.S. Cl. 48/61; 48/198.1

(57) ABSTRACT

A hydrogen generation system includes a hydrogen generator reacting a steam/methane mixture. Calcium oxide particles in the hydrogen generator absorb a substantial reacted portion of carbon dioxide from the reacted steam/methane mixture. The hydrogen generator discharges a hydrogen/COx gas volume. A methanation unit subsequently converts substantially all of the COx portion of the hydrogen/COx gas volume to methane gas.

### FIELD OF THE INVENTION

The present invention relates in general to hydrogen generation by steam reforming of natural gas and more specifically to a device and method for purifying a hydrogen gas separated from a solids/gaseous flow stream used in such a reforming process.

### BACKGROUND OF THE INVENTION

The generation of hydrogen from natural gas via steam reforming is a well established commercial process. One drawback is that commercial units tend to be extremely large in volume and subject to significant amounts of methane slip, identified as methane feedstock which passes through the reformer un-reacted.

To reduce the size and increase conversion efficiency of the units, a process has been developed which uses calcium oxide to improve hydrogen yield by removing carbon dioxide generated in the reforming process. See U.S. patent application Ser. No. 10/271,406 entitled “HYDROGEN GENERATION APPARATUS AND METHOD”, filed Oct. 15, 2002, commonly assigned to the assignee of the present invention, the disclosure of which is incorporated herein by reference. The calcium oxide reacts with the product CO₂ in a separation reaction, producing a solid calcium carbonate (CaCO₃) and absorbing the CO₂, producing a hydrogen rich gas.

The hydrogen gas leaving the hydrogen generator may not meet industry purity requirements. A small amount of methane, CO and/or CO₂ carryover also occurs. To further increase hydrogen purity, the hydrogen/methane/CO/CO₂ gas mixture can be directed through a device such as a pressure swing absorber (PSA). Use of PSAs can produce a hydrogen end product of 99.9% purity or greater. One drawback of PSA use is the high cost of the system/end product. A further drawback is that as the bed of the PSA becomes saturated, the PSA must be depressurized, normally to atmospheric pressure, to drive off the absorbed CH4, CO and CO₂. This normally requires that for continuous system operation, at least two PSAs must be provided, such that one can be regenerated while the other is in operation. Another drawback of PSAs is that system pressure must then be returned to its elevated operating pressure, to recycle the remaining methane as additional fuel, which normally requires a compressor. A compressor further increases system complexity and cost while lowering process efficiency. Many users of hydrogen do not require purity of 94% or greater and therefore a device which purifies a hydrogen flow stream (by eliminating toxic carbon monoxide (CO) gas) at elevated temperature and pressure but at reduced product cost is desirable.

### SUMMARY OF THE INVENTION

According to a preferred embodiment of the present invention, a hydrogen generation system includes a hydrogen generator receiving a steam/methane mixture. Calcium oxide particles in the hydrogen generator absorb a substantial reacted portion of carbon dioxide from the steam/methane mixture. The hydrogen generator discharges a hydrogen/COx gas volume which also contains a low volume of methane gas (<6 vol % dry basis). A methanation unit converts subsequently all of the low amounts of COx gas (approximately 0.2 vol % dry basis) to additional methane.

According to another preferred embodiment of the present invention, a methane to hydrogen generation system includes a steam/methane mixture. A hydrogen generator reacts the steam/methane mixture into at least a plurality of gases, including at least a carbon dioxide gas and a hydrogen gas. A plurality of calcium oxide particles entrainable with the steam/methane mixture absorbs a portion of the carbon dioxide reacted within the hydrogen generator. A cyclone separator separates the calcium oxide particles from the plurality of gases. A methanation unit positioned downstream of the cyclone separator substantially converts all undesirable COx within the hydrogen rich product gas stream to methane.

According to yet another preferred embodiment of the present invention, a method for converting low amounts of COx in a hydrogen gas from a plurality of byproduct gases reacted in a steam/methane reformer includes: reacting a steam/methane mixture in a hydrogen generator to create the hydrogen gas, the carbon dioxide gas and the carbon monoxide gas; absorbing a first portion of the carbon dioxide gas using a plurality of calcium oxide particles; discharging the hydrogen gas, the carbon monoxide gas and a second portion of the carbon dioxide gas from the hydrogen generator; and substantially converting the low amounts of COx in the hydrogen gas to methane in a methanation unit.

A hydrogen generation system with methanation unit of the present invention offers several advantages. By using a methanation unit, system operation can be continuous at elevated temperatures without the need to periodically depressurize and regenerate solid absorbents or catalysts. Only one methanation unit is required compared to at least two PSA units normally used for this purpose.

The features, functions, and advantages can be achieved independently in various embodiments of the present invention or may be combined in yet other embodiments.

### BRIEF DESCRIPTION OF THE DRAWINGS

The present invention will become more fully understood from the detailed description and the accompanying drawings, wherein:

FIG. 1 is a diagrammatic view of a hydrogen generation system with methanation unit according to a preferred embodiment of the present invention;

FIG. 2 is a diagrammatic view of a methanation unit portion of the system of FIG. 1; and

FIG. 3 is a cross sectional view of a methanation unit of the present invention.

### DETAILED DESCRIPTION OF THE PREFERRED EMBODIMENTS

The following description of the preferred embodiments is merely exemplary in nature and is in no way intended to limit the invention, its application, or uses.

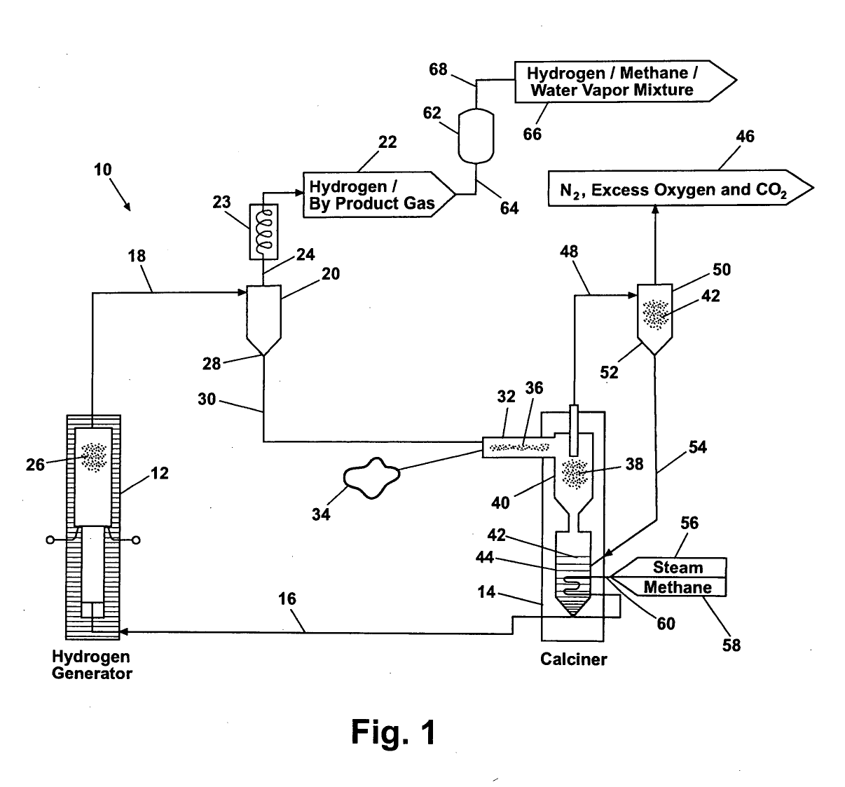

Referring generally to FIG. 1, according to a preferred embodiment of the present invention, a reformation system 10 includes a hydrogen generator 12 which receives reaction products from a calciner 14 via a generator feed line 16. Discharge from the hydrogen generator 12 is provided via a generator discharge line 18 to a hydrogen cyclone separator 20. A hydrogen/byproduct gas 22 is largely removed from hydrogen cyclone separator 20 and cooled by passing through a heat exchanger 23 via a hydrogen discharge line 24. A plurality of calcium carbonate (CaCO₃) particles 26, which are entrained in a flow that can contain hydrogen, steam and nitrogen gases from hydrogen generator 12, are separated and collected for discharge at a discharge end 28 of hydrogen cyclone separator 20. The calcium carbonate particles 26 are transferred via a return line 30 back to calciner 14.

Return line 30 connects to a calciner inlet 32 of calciner 14. A hot, vitiated air volume 34 is introduced in calciner inlet 32 which together with the calcium carbonate particles 26 form a mixture 36. Regeneration of the calcium carbonate particles 26 back to calcium oxide occurs primarily within calciner inlet 32. As a result of the regeneration process, as well as the addition of steam and methane as noted below, a calcium oxide/nitrogen/carbon dioxide mixture 38 is created within a cyclone separator 40. A plurality of relatively heavier calcium oxide particles 42 are separated within cyclone separator 40 and fall into a hopper 44 within calciner 14. A gas volume 46 containing primarily nitrogen and carbon dioxide gases, together with a small carryover volume of calcium oxide particles 42, is discharged from cyclone separator 40 via a gas discharge line 48 to a cyclone separator 50.

Gas volume 46 is discharged from cyclone separator 50, leaving the carryover volume of calcium oxide particles 42 to collect in a bottom hopper area 52 of cyclone separator 50. The carryover volume of calcium oxide particles 42 is returned via a calciner input line 54 to hopper 44 of calciner 14. A steam supply 56 and a methane supply 58 are connected to calciner 14 and a steam/methane mixture 60 together with the regenerated calcium oxide particles 42 are transferred to hydrogen generator 12 to repeat the process. Hydrogen/byproduct gas 22 is directed into a methanation unit 62 via a methanation unit inlet line 64. Hydrogen/byproduct gas 22 can contain at least hydrogen gas, carbon monoxide gas, carbon dioxide gas, water vapor, and/or unreacted methane. A mixture 66 containing primarily hydrogen, methane, and water vapor is discharged from methanation unit 62 via a methanation unit discharge line 68.

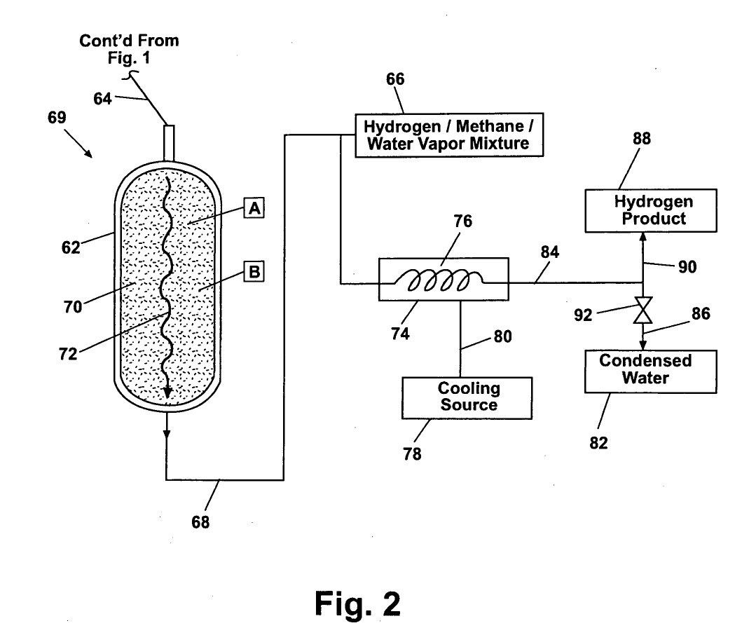

Heat exchanger 23 is provided to reduce the temperature of hydrogen/by product gas 22 from its reaction temperature of approximately 649° C. (1200° F.) to approximately 288° C. (550° F.). This reduced temperature is required to avoid damaging a methanation catalyst 70 (described in reference to FIG. 2) provided in methanation unit 62. Heat exchanger 23 can be supplied with any suitable coolant including steam, chilled water, etc. (not shown).

During operation of reformation system 10, hydrogen generator 12 reacts steam from steam supply 56 and methane from methane supply 58 to generate hydrogen and carbon dioxide. The carbon dioxide is removed from hydrogen generator 12 by reaction with the calcium oxide particles 42 entrained with steam/methane mixture 60. The hydrogen/byproduct gas 22 is separated from the calcium carbonate particles 26 via hydrogen cyclone separator 20 as previously discussed. As the calcium oxide particles 42 absorb a first or substantial portion of the carbon dioxide in hydrogen generator 12, calcium carbonate particles 26 are formed which are transferred in particulate form out of hydrogen cyclone separator 20 to calciner inlet 32. Hot, vitiated air volume 34 impinges and reacts with the calcium carbonate particles 26 in calciner inlet 32 to reform calcium oxide particles 42 from mixture 36, which subsequently enter cyclone separator 40 of calciner 14. Within cyclone separator 40, the calcium oxide particles 42 and calcium oxide/nitrogen/carbon dioxide mixture 38 are separated, with the calcium oxide particles 42 dropping down into hopper 44. During operation of reformation system 10, calcium carbonate particles 26 are continuously reformed to calcium oxide particles 42 and returned in particulate form with steam/methane mixture 60 to hydrogen generator 12.

Referring now to FIG. 2, in a product discharge sub-portion 69 of reformation system 10, methanation unit 62 includes methanation catalyst 70. Hydrogen/byproduct gas 22 enters methanation unit 62 at approximately 288° C. (550° F.) and follows a generally downward, tortuous path 72 through methanation catalyst 70 to discharge line 68. Methanation catalyst 70 converts substantially all of a carbon dioxide gas “A” and a carbon monoxide gas “B” to methane gas according to the following reactions.
CO(g)+3H₂(g)→CH₄(g)+H₂O(g) (R-1)
and:
CO₂(g)+4H₂(g)→CH₄(g)+2H₂O(g) (R-2)

A total gas volume of hydrogen/by-product gas 22 entering methanator 62 includes at least a hydrogen gas, a volume of unreacted methane gas and a COx gas. The COx gas includes at least carbon monoxide gas “B” as a first partial volume and carbon dioxide gas “A” as a second partial volume. In an equilibrium condition of a preferred embodiment of the present invention, the total gas volume of hydrogen/by-product gas 22 discharged from hydrogen generator 12 includes: approximately 506 ppm (dry basis) of the first partial volume of carbon monoxide; approximately 952 ppm (dry basis) of the second partial volume of carbon dioxide; approximately 4.87 vol % (dry basis) of the unreacted volume of methane; and approximately 94.98 vol % (dry basis) of the hydrogen gas. Each of the carbon dioxide gas “A” and the carbon monoxide gas “B” are substantially reacted in methanator 62 to additional methane gas.

Hydrogen/methane/water vapor mixture 66 that passes through methane catalyst bed 70 is transferred via discharge line 68 to a cooling device 74. A coolant 76 provided to cooling device 74 reduces the temperature of mixture 66 from approximately 315° C. (600° F.) to a saturated steam temperature of approximately 170° C. (338° F.), or lower, at the reformation system 10 operating pressure of 0.793 MPa (115 psia). At this temperature, the water vapor portion of hydrogen/methane/water vapor mixture 66 condenses to create a condensed water volume 82, which is discharged via a cooling device discharge line 84 to a drain 86. A remaining dry hydrogen product 88 is discharged via a product discharge line 90.

A pressure reducing device 92 can also be used to reduce reformation system 10 pressure from the 0.793 MPa (115 psia) normal operating pressure to approximately atmospheric pressure for discharging condensed water volume 82. Coolant 76 can be provided by a cooling source 78 via a coolant supply line 80. Coolant 76 is preferably a chilled air or chilled water, but coolant 76 can be any type of cooling medium sufficient to reduce the temperature of mixture 66 to its saturated steam temperature. Dry hydrogen product 88 can contain both hydrogen gas and a carryover volume of unreacted methane gas.

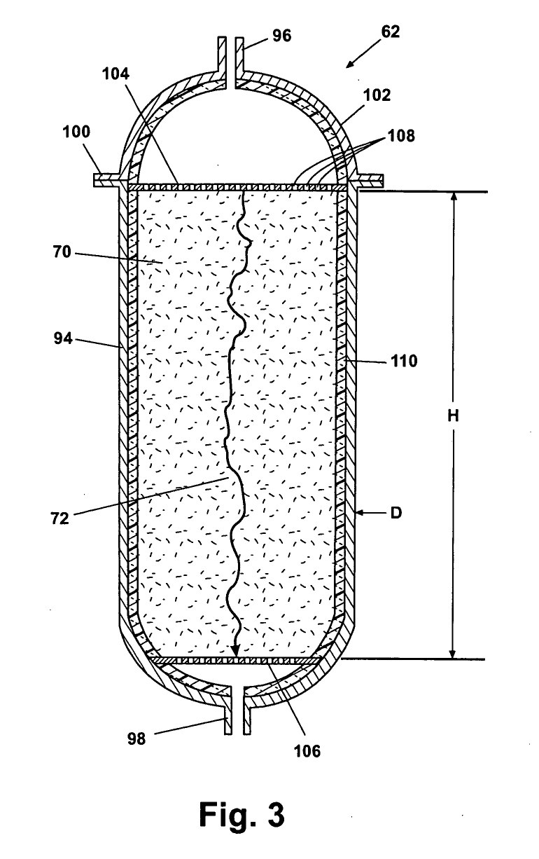

Referring now to FIG. 3, methanation unit 62 can include a cylindrical body 94 having an inlet nozzle 96 and an outlet nozzle 98. A flanged joint 100 can be used to permit methanation unit 62 to be disassembled for loading or unloading of methanation catalyst 70. For methanation catalyst loading/unloading, one or more removable sections 102 can be provided. An upper screening device 104 and a lower screening device 106 can be used to contain methanation catalyst 70. Each of the upper screening device 104 and the lower screening device 106 can include a plurality of apertures 108 sized to permit gas passage while preventing passage of methanation catalyst 70. Within methanation unit 62 a plurality of tortuous paths 72 are provided through methanation catalyst 70 for hydrogen/byproduct gas 22 to flow, permitting retention of the entrained carbon dioxide gas and carbon monoxide gas. As previously noted, flow through methanation unit 62 is generally in a downward direction, but the direction of tortuous paths 72 do not limit the invention and can vary from that shown.

Because of the elevated temperature of hydrogen/byproduct gas 22, at approximately 288° C. (550° F.), and the possibility of hydrogen embrittlement, methanation unit 62 can also be provided with an insulation layer 110. Insulation layer 110 can include a ceramic or a ceramic matrix composite material. Material for methanation unit 62, including body 94, inlet nozzle 96, outlet nozzle 98, upper screening device 104, lower screening device 106 and flanged joint 100 can be steel or a cobalt based alloy such as Haynes® Alloy 188. In a preferred embodiment of the present invention, system operating temperature for the methanation unit is approximately 288° C. (550° F.), at which insulation layer 110 can be optionally eliminated.

Methanation catalyst 70 is commercially available via suppliers such as Haldor-Topsoe (Houston, Tex.). Methanation unit 62 is sized, for example using a height “H” and a diameter “D” given a selected volumetric flow rate of hydrogen gas per day through the unit and a reaction rate of methanation catalyst 70, which can vary from supplier to supplier. In a preferred embodiment of the present invention, a flow rate of 60,000,000 standard cubic feet per day (scf/day) of hydrogen is used to size methanation unit 62. The methanation catalyst 70 should be selected for particular affinity for the reaction of carbon dioxide and/or carbon monoxide with hydrogen to gaseous methane. Methanation unit 62 is not limited to the cylindrical shape described herein, but is sized at the discretion of the designer, taking into account available plant space, construction cost and access for loading/unloading of methanation catalyst 70. Other geometric shapes can be used, including square, rectangular, oval, etc.

A hydrogen generation system with methanation unit of the present invention offers several advantages. By using a methanation unit, system operation can be continuous at elevated methanation temperatures ranging between approximately 205° C. (400° F.) up to approximately 371° C. (700° F.) without the need to periodically depressurize and regenerate a PSA absorbent. Only one methanation unit is required compared to two PSA units normally used for this purpose. Methanation units of the present invention offer a lower cost alternative where substantially pure hydrogen product (greater than approximately 94% purity) is not required.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A hydrogen generation system, comprising:
a steam/methane mixture;
a hydrogen generator operable to receive the steam/methane mixture, the hydrogen generator having at least a plurality of calcium oxide particles operable to absorb a substantial reacted portion of carbon dioxide from the steam/methane mixture;
a total gas volume including each of a hydrogen gas volume, an unreacted methane gas volume and a COx gas volume operably discharged from the hydrogen generator; and
a methanation unit operable to convert substantially all of the COx gas volume to an additional methane gas volume.

2. The system of claim 1, comprising a cyclone separator positionable between the hydrogen generator and the methanation unit.

3. The system of claim 2, comprising a mixture containing the calcium oxide particles and the total gas volume, the mixture being operably separable in the cyclone separator.

4. The system of claim 1, comprising a methanation catalyst disposable within the methanation unit.

5. The system of claim 1, wherein the COx gas volume further comprises:
a first partial volume of carbon monoxide; and
a second partial volume of carbon dioxide.

6. The system of claim 5, comprising a combined concentration of the first partial volume of carbon monoxide and the second partial volume of carbon dioxide exiting the methanation unit of 10 ppm.

7. The system of claim 5, wherein in an equilibrium condition the total gas volume discharged from the hydrogen generator comprises:
approximately 506 ppm dry basis of the first partial volume of carbon monoxide;
approximately 952 ppm dry basis of the second partial volume of carbon dioxide;
approximately 4.87 vol % dry basis of the unreacted volume of methane; and
approximately 94.98 vol % dry basis of the hydrogen gas.

8. The system of claim 5, wherein a system nominal operating pressure is approximately 0.793 MPa.

9. The system of claim 1, comprising:
a supply of steam; and
a supply of methane combinable with the supply of steam to operably form the steam/methane mixture.

10. The system of claim 1, comprising an insulation material positionable within the methanation unit.

11. A methane to hydrogen generation system, comprising:
a steam/methane mixture;
a hydrogen generator operable to react the steam/methane mixture into at least a plurality of gases, the plurality of gases including at least a COx gas and a hydrogen gas;
a plurality of carbon dioxide absorbant particles entrainable with the steam/methane mixture operable to substantially absorb a portion of the carbon dioxide reacted within the hydrogen generator;
a cyclone separator operable to separate the carbon dioxide absorbant particles from the plurality of gases; and
a methanation unit positioned downstream of the cyclone separator, the methanation unit operable to convert substantially all of the COx gas to a reacted methane gas.

12. The system of claim 11, comprising a plurality of calcium carbonate particles operably created by absorption of the carbon dioxide by the plurality of carbon dioxide absorbant particles.

13. The system of claim 12, comprising a calciner device operable to regenerate substantially all of the plurality of calcium carbonate particles to calcium oxide.

14. The system of claim 11, comprising:
a system operating pressure of approximately 0.793 MPa; and
a methanator operating temperature ranging between approximately 205° C. to approximately 371° C.

15. The system of claim 11, wherein the methanation unit comprises a cylinder.

16. The system of claim 15, further comprising a methanation catalyst receivable within the cylinder.

17. The system of claim 15, wherein the cylinder further comprises:
an inlet in communication with the cyclone separator; and
a discharge outlet downstream of the methanation catalyst.

18. The system of claim 17, further comprising:
an unreacted portion of methane gas included with the plurality of gases; and
a cooling device operable to receive the hydrogen gas, the reacted methane gas and the unreacted portion of methane gas from the discharge outlet and condense a water volume.

19. The system of claim 18, further comprising a drain operable to discharge the water volume.

20. A method for producing a hydrogen gas and a plurality of byproduct gases, the plurality of byproduct gases including at least a carbon dioxide gas, a carbon monoxide gas and a water vapor, the method comprising:
reacting a steam/methane mixture in a hydrogen generator to operably create the hydrogen gas and the plurality of byproduct gases;
absorbing a first portion of the carbon dioxide gas using a plurality of calcium oxide particles;
discharging the hydrogen gas, the water vapor, the carbon monoxide gas and a second portion of the carbon dioxide gas into a methanation unit; and
converting substantially all of the carbon monoxide gas and the second portion of the carbon dioxide gas to a methane gas in the methanation unit.

21. The method of claim 20, comprising injecting a plurality of calcium oxide particles together with the steam/methane mixture into the hydrogen generator prior to the reacting step.

22. The method of claim 20, comprising maintaining a combination including the carbon monoxide gas and the second portion of the carbon dioxide gas dischargeable from the methanation unit at a maximum concentration of 10 ppm.

23. The method of claim 20, comprising inserting a methanation catalyst in the methanation unit.

24. The method of claim 20, comprising transferring the hydrogen gas, the methane gas, and the water vapor from the methanation unit into a cooling device.

25. The method of claim 20, comprising cooling the hydrogen gas, the methane gas, and the water vapor using the cooling device to substantially condense the water vapor.

26. The method of claim 25, comprising draining the condensed water vapor.

27. A method for using a methanation unit in conjunction with a hydrogen generation system, the system having a hydrogen generator, a plurality of calcium oxide particles and a cyclone separator, the method comprising:
reacting a steam and methane mixture in the hydrogen generator to operably create a hydrogen containing gas;
absorbing a first portion of a carbon dioxide gas from the hydrogen containing gas in the hydrogen generator using the plurality of calcium oxide particles, operably creating a plurality of calcium carbonate particles;
separating the calcium carbonate particles from the hydrogen containing gas in the cyclone separator; and
converting at least a second portion of the carbon dioxide gas to a methane gas in the methanation unit.

28. The method of claim 27, comprising reacting the calcium carbonate particles in a calciner unit to operably regenerate the plurality of calcium oxide particles from the calcium carbonate particles.

29. The method of claim 28, comprising transferring the reacted calcium oxide particles from the calciner unit to the hydrogen generator.

30. The method of claim 27, comprising loading a methanation catalyst into the methanation unit, the methanation catalyst having an affinity to convert at least the second portion of the carbon dioxide gas to the methane gas.

31. The method of claim 27, comprising loading a methanation catalyst into the methanation unit, the methanation catalyst operable to react both the second portion of the carbon dioxide gas and a carbon monoxide gas to the methane gas.

32. The method of claim 27, comprising cooling the hydrogen containing gas to operably condense a water vapor entrained in the hydrogen containing gas.

33. The method of claim 27, comprising operating the methanation unit at a temperature ranging from approximately 205° C. to approximately 371° C.
